(19) United States
(12) Patent Application Publication
(10) Pub. No.: US 2003/0036395 A1
(43) Pub. Date: Feb. 20, 2003

(54) Method of and system for providing a programming information for programming a device

(75) Inventor: Adolf Proidl, Vienna (AT)

Correspondence Address: Corporate Patent Counsel, U.S. Philips Corporation, 580 white Plains Road, Tarrytown, NY, 10591, US

(73) Assignee: KONINKLIJKE PHILIPS ELECTRONICS N.V.

(21) Appl. No.: 10/213,553

(22) Filed: Aug. 7, 2002

(30) Foreign Application Priority Data
Aug. 14, 2001 (EP) 01 890 235.3

(51) Int. Cl. H04Q 7/20

(52) U.S. Cl. 455/466; 455/419

(57) ABSTRACT

The invention relates to a method and an information providing system (IS) for making a programming information (PI) available for the programming of a programmable device or appliance (1), which programming information (PI) is selected from a database (3) and is transmitted as an electronically transmittable message, in particular as a short message (SMS), to a communication device (11) designed for receiving short messages (SMS) and formed, for example, by a mobile telephone, and which programming information (PI) is made available by the communication device (11) to the programmable device or appliance (1). The selected programming information (PI) may be selected, for example, through a terminal (5) which is connected to the information providing system (IS) via a data network (4), in particular the Internet. The selection may alternatively take place through the communication device (11), for example in accordance with the Wireless Application Protocol (WAP) or short messages (SMS). The invention substantially simplifies the programming of programmable devices (1), for example video recorders.

The invention relates to a method of providing a programming information for programming a programmable device or appliance, further to an information providing system for providing a programming information for a programmable device or appliance, and to a communication device for providing a programming information to a programmable device or appliance, and to a method of programming a programmable device or appliance by means of a communication device, and finally to a signal for transmitting a programming information to a communication device.

Almost every household has a number of appliances which have a programming function. Examples of this are recording devices such as a video recorder, cassette recorder, and the like, hi-fi installations or telephone home exchanges, or a number of other domestic appliances such as, for example, washing machines, coffee makers, and many more, jointly referred to as “consumer electronics products”. The present invention, however, may also be applied to devices outside private households, for industrial use.

The large quantity of programmable appliances and the widely differing programming methods render an easily understood and easily performed programming practically impossible, which is why the user of the relevant devices must spend much time in studying the operating instructions, which considerably reduces the acceptance of many appliances. The remote controls, which are of different designs from one appliance to the next, do not make things any easier because of the plurality of designs.

Methods have been developed, in particular for video recorders, which facilitate the programming of the video recorder. For example, codes are indicated in program guides for the respective TV broadcasts which contain the relevant programming information. The video recorder can be programmed to record the desired broadcast in that the respective code is entered. To achieve this, however, either a suitable module must be contained in the video recorder or a suitable device is to be purchased afterwards, which device converts the codes, i.e. the coded information, into a form understandable for the video recorder, i.e. the programming information. In addition, not all TV broadcasts are given such a code, which means that the conventional manual programming method must be used for recording such TV broadcasts.

Recently so-called “Electronic Programming Guide (EPG)” servers have come into use, which scan data sources available in particular on the Internet, register programming information on TV or radio broadcasts, and store them in their own database. To support the programming of, for example, a video recorder, the programming information present in the database of the EPG server may be loaded into the memory of the video recorder. For this purpose, for example, the desired broadcast is selected on the home page of the EPG server by means of a personal computer with a suitable Internet browser, and the most important identification data are supplied to the EPG server, which identification data render it possible to identify the video recorder or the personal computer or the owner of these devices. The EPG server subsequently sends the relevant programming information to a broadcasting organization which broadcasts this programming information along with the teletext signal in the horizontal scanning void. A video recorder fitted with a special reception module is capable of identifying the programming information transmitted along with the teletext signal and of extracting it from the teletext signal. A disadvantage of this is not only that a specially constructed video recorder is necessary, but that the latter must always be switched on so as to be capable of receiving the programming information. In addition, a system-dependent delay of up to several hours from the moment of selecting the programming information up to the reception thereof in the video recorder may take place, which is a disadvantage because a spontaneous recording triggered by the programming is not possible. Furthermore, this manner of transmitting the programming information, i.e. by transmission in the TV signal, is very expensive for reasons of cable occupancy.

The patent document U.S. Pat. No. 5,880,769 A describes a data carrier in the form of a smart card which is designed for receiving data by means of a photosensor. The data carrier comprises a modem by means of which a service provider can be contacted via a telephone line so as to obtain desired data. The photosensor is also capable of receiving invisible information radiated by the TV set, which information may be coded, for example, in accordance with the so-termed RC5 standard. The user of the smart card may thus transfer the relevant information such as, for example, date and time of a TV broadcast, onto the smart card and subsequently insert the card into the remote control of the video recorder, so that the programming information is transmitted to the video recorder via the remote control only. A disadvantage is that the desired programming information is radiated by the TV set at certain times only, for example during a program preview, and that the storage on the smart card can take place only at precisely that moment. It is unfortunately not possible to select the suitable programming information at any time desired and to utilize it at any other moment for programming the video recorder.

It is accordingly an object of the invention to simplify the programming of programmable devices or appliances such that users can utilize procedures and appliances to which they are accustomed. In addition, the present invention has for its object to provide an information providing system for providing a programming information for a programmable appliance which serves to support a programming method. Further objects are the creation of a communication device for providing a programming information for a simple implementation of a programming method as well as the creation of a method of programming a programmable appliance by means of a communication device, and the realization of a signal for transmitting a programming information to a communication device.

The first object of the invention is achieved in that the programming information is selected from a database, and the programming information is transmitted to a communication device in the form of an electronically transmittable message, said communication device being designed for receiving said message, and the programming information is made available to the programmable appliance by the communication device. The method of programming an appliance is substantially facilitated by the use of a communication device such as, for example, a mobile telephone or some other, preferably portable device, which is capable of receiving electronically transmittable messages, for example palmtops, notebooks, or so-termed Personal Digital Assistants (PDAs) with which the respective user is familiar. In addition, a communication device may be used for programming a plurality of appliances. The transmission of the programming information as a message or in a message which can be transmitted electronically and which contains the alphanumerical symbols in binary or decimal or hexadecimal or alphabetical or a mixed form can also be carried out in a fast and inexpensive manner. Such a message, which is electronically transmittable, may be a message based on a markup language. It may alternatively be a so-termed SMS. The latter possibility, which was created in mobile telephone networks based on GSM (Global System for Mobile communication), serves to transmit short messages between mobile telephones or terminals limited to 160 alphanumerical symbols. It is possible to transmit not only short text messages, but also images or sounds by SMS. To transmit the programming information, a short message will usually suffice. It would also be possible to bring together several so-termed segmented short messages for the transmission of longer programming data. The method according to the invention enables the user to select the desired, available programming information, for example via a telephone or computer link, whereupon this information is transmitted as a short message to his or her communication device after a comparatively short time. The user can then program the programmable appliance, for example the video recorder, by transmitting the programming information from the communication device to the programmable appliance at a moment determined by him or her. The use of, for example, a mobile telephone is familiar to the user because of the wide use thereof, which simplifies the programming of the respective appliance.

The selection of the available programming information is made easier in that the latter is selected from the database via a data network, in particular via the Internet. A server accessible in the data network, in particular in the Internet, may then offer the programming information in a known manner, which information may be requested and selected via a personal computer or alternatively a mobile telephone or the like.

Similarly, the programming information may be made available on a server which is accessible by telephone, in which case the desired programming information may be selected in a speech-controlled manner, whereupon said information is transmitted as a short message, for example to the mobile telephone serving as the communication device. If a mobile telephone is used, the server may also automatically recognize the mobile telephone number by means of the CLIP (Calling Line Identification Presentation) service which is made available in GSM networks and which renders possible a display of the calling number of the caller at the other side, such that the short message is transmitted to the correct end user. The selection of the programming information by means of a speech signal has the additional advantage that no terminal or computer need be available, but that the selection may be made from any location by means of the mobile telephone.

Instead of selecting the programming information by means of a speech signal, it is also possible to select the programming information from the database by means of the communication device through the use of the Wireless Application Protocol (WAP). The programming information or a selection therefrom may be presented on a display at the communication device, and the desired programming information may be selected, whereupon a short message is sent to the communication device comprising the relevant programming information.

Alternatively, the programming information may be selected from the database by means of a message generated with the communication device. In this case the user sends a short message with corresponding information through the communication device to the information providing system, whereupon at least one piece of programming information is transmitted as a short message to the communication device, provided a suitable programming information in accordance with the request sent by the user is available. If a suitable programming information should not be available or not at that very moment, a message without programming information may be sent back to the user for informing him or her.

If a user identification is performed before the selection of the programming information, an unauthorized use can be prevented in the first place, and in the second place a correct invoice may be sent for the supply of the programming information. In addition, the identification renders possible an automatic creation of a user profile through the storage of user-specific data, for example in a user database.

Besides the automatic creation of a user profile, user-specific data may also be entered by the user after the user identification and may be stored in the user database. In that case, for example, certain preferences or fields of interest may be entered or may be selected from an existing list. Furthermore, relevant data on a programmable appliance of the user may be entered in the user database. The user-specific data are accordingly always available and are automatically used in an identification of the user for the method according to the invention, so that they need not be selected or entered anew at each and every programming action.

Statistical data on the user-specific selection of the programming information or other events may be stored in a statistical database and may be used for determining user profiles or for payment.

If the selection of the programming information and the transmission thereof as a message to the communication device takes place automatically, preferably taking into account the user-specific data of the user database and/or the statistical data of the statistical database, the user of the method according to the invention can be served with a selected list of programming data without his or her own intervention, from which list he or she may select certain information for programming his or her appliances, for example a video recorder, as desired. User-specific data entered by the user or automatically assumed data reflecting the user's behavior may be used for a preselection of the programming information. Obviously, the user must give permission for such an automatic transmission of programming information during his or her identification.

In the method according to the invention, the programming information is used in particular for programming a programmable recording device, in particular a video recorder. Other magnetic tape recording devices or optically operating recording devices, such as CD devices or DVD devices, also fall within the scope of the method according to the invention. The latter, however, is by no means limited to recording and playback devices, since the method according to the invention can be used in a plurality of other fields, for example for programming domestic appliances. For example, the method described could be used for sending a programming information to a communication device of an authorized person by means of a message, for example a short message (SMS), by means of which an access control system can be managed. A further example of an application of the method is the transmission of the electronic key for a hired car which is transmitted to the customer after a corresponding payment in the form of a short message to a communication device, for example to his mobile telephone, so that the customer can open and start the hired car without having to visit the car hire company. Innumerable further fields of application are conceivable in addition thereto.

A further conceivable application of the present invention would lie, for example, in the field of traffic information, where traffic information on a certain region could be requested by means of a short message generated with a communication device of a traveler, and the relevant information could be transmitted as a short message to the communication device of the traveler. A programming information contained in the short message could, for example, be transmitted to a traffic control device constructed as a programmable appliance and could be processed accordingly thereby. The traffic control device could, for example, offer the traveler the most favorable route to a given destination, taking into account any tailbacks or roadworks, by means of the corresponding programming information.

The object of the invention is also achieved by an information providing system for providing a programming information for a programmable device or appliance, which information providing system comprises a database containing the programming information, from which database the programming information can be selected, and furthermore comprises a device for forming a message which can be electronically transmitted and which represents the selected programming information, as well as output means for providing the message to a communication device which is equipped for making the programming information available to the programmable device or appliance. Such an information providing system may be formed, for example, by a server in a data network, in particular the Internet, as used at present in the so-termed “Electronic Programming Guide” (EPG) servers. Such an information providing system is equipped with a transmission unit for transmitting messages, in particular short messages, and suitable means are provided for the transmission of messages, in particular short messages, for example to an operator of a mobile telephone network. Before a message is sent, the relevant programming information selected by the user is brought into a suitable data format, and the message is provided with an identifying signal portion for identifying the programming information. Upon receiving a message, accordingly, a communication device may unequivocally ascertain what kind of message is involved. For example, the communication device may be constructed for displaying a user information contained in the message and for suppressing a display of the programming information.

As was noted above, the output means of the information providing system may be designed for making contact with a transmission unit of a mobile telephone network for the transmission of the messages, so that no transmission device for sending the message need be contained in the information providing system itself.

Preferably, identification means for identifying the user selecting the programming information are provided in the information providing system. This measure renders it possible to prevent misuse, and also to protocol and evaluate the behavior of the user in all cases. In addition, the identification renders possible a correct invoicing.

A user database may be present in the information providing system for the storage of user-specific data. Personal data of the user such as the address, telephone number, age, and certain preferences or fields of interest, may be stored in this user database. On the other hand, information on a programmable device, for example the type of a video recorder, may be stored in the user database, so that these data need not be entered or selected anew at each and every programming action, but are continuously available in the information providing system. The data stored in the user database are preferably automatically called up in the selection process of the programming information by the user and are utilized for the subsequent process, as desired. The automatic recognition of the user may be achieved, for example, by the CLIP (Calling Line Identification Presentation) service in the GSM network, or alternatively by so-termed cookies in Internet applications.

Furthermore, a statistical database may be provided for the storage of statistical data, which may serve, for example, for invoicing or alternatively for market research and the like.

Encoding and decoding means of a usual kind may be provided in the information providing system for the purpose of encoding and decoding the user-specific data and the statistical data. A misuse and a violation of the data protection may be prevented thereby.

A user-friendly selection method for the programming information may be achieved in a device for speech-controlled selection of the programming information by the user, i.e. also for persons who do not have an input terminal such as a personal computer. In addition, the speech-controlled selection is possible at any time and from any location, for example via a mobile telephone.

Furthermore, a device may be provided for selecting the programming information by means of a message, which message (SMS) can be generated by the communication device.

A specially designed device may be provided for making possible an automatic selection of the programming information while taking into account the user-specific data and/or the statistical data. Usually, such a device will be formed by a computer which makes a relevant selection from the programming information on the basis of the user-specific data.

To facilitate a selection of the programming information by the user, linking means to a data network, in particular to the Internet, are preferably provided in the information providing system. The programming information may be called up and selected from any computer with Internet access or WAP-capable mobile telephones thanks to this measure.

The further object of the invention is achieved by means of a communication device for providing a programming information for a programmable device, comprising a receiver unit for receiving an electronically transmittable message, and comprising a recognition device for recognizing the programming information transmitted as a message, and with means for making the programming information available to the programmable appliance. The term “communication device” relates in particular to mobile user devices, for example mobile telephones or handheld computers or notebooks which are capable of receiving electronically transmittable messages, for example short messages (SMS), and which are capable of recognizing these messages as containing programming information for a programmable appliance. The recognized programming information, which was possibly extracted from the message, may subsequently be transmitted, i.e. passed on to the programmable appliance at any moment convenient to the user. If the communication device is a mobile telephone, most features of the invention are already present in commercially available appliances, but not the feature that a recognition device for recognizing the programming information transmitted in the form of a message is provided. Such a recognition device may be realized in an inexpensive manner in that the module for processing messages usually contained in a mobile telephone is expanded. The means for providing the programming information to the programmable appliance may be formed by the infrared interface unit usually present in a mobile telephone.

If the means for providing the programming information to the programmable device are also constructed for the reception of signals, in particular signals originating from the programmable appliance, a communication between the communication device and the programmable appliance can take place in both directions. For example, after the programming information has been passed on to the programmable appliance, a message may be sent by the latter to the communication device, either acknowledging the correct programming or signaling a programming error.

As was noted above, the means for providing the programming information may be formed by an infrared interface unit. This has the advantage that no cable link is to be built up. It is obviously also possible that there are wired connections or radio links between the communication device and the programmable appliance.

To render possible a programming of several appliances, a device for selecting a coding type for the programming information in dependence on the programmable appliance may be provided in the communication device. For example, the coding types usual for programming video recorders may be contained in the communication device and may be selected when necessary.

If the communication device is a mobile telephone, the inherent advantages of its low-weight and familiar operation will be a bonus.

The object of the invention is also achieved by means of a method of programming a programmable device or appliance by means of a communication device as described above, wherein the programming information is formed through the use of a message put into intermediate storage in the communication device, and wherein the programming information is transmitted to the programmable device or appliance by the communication device. The transmission of the programming information to the programmable appliance preferably takes place in a wireless manner, for example via an infrared link.

According to a further characteristic of a method according to the invention, the programming information is transmitted in the so-termed RC5 format. This format is a standardized format for programming video recorders. Usually, the programming information is contained in a so-termed timer string which is coded in the RC5 format and is transmitted to the programmable device.

The object of the invention is also achieved by a signal which represents a message which can be electronically transmitted to a communication device and which is designed so as to transmit a programming information to the communication station, while at least one signal component of the signal represents a programming information for programming a programmable device or appliance.

It was found to be particularly advantageous in this connection if the signal comprises an identification signal component for identifying the programming information. This identification signal component for identifying the programming information may be formed, for example, by a string of characters in hexadecimal code, or a string of characters in accordance with the Extensible Markup Language (XML) standard. The latter embodiment has the advantage of being more readily readable, because the data components are unequivocally identifiable in the Extensible Markup Language (XML) standard and are not present in encoded form in unreadable strings of characters.

The signal for transmitting the programming information to the communication device preferably comprises a signal carrier in a frequency range around 36 kHz.

The invention will now be explained in more detail with reference to preferred embodiments to which, however, it is not limited, and with reference to the drawings, in which:

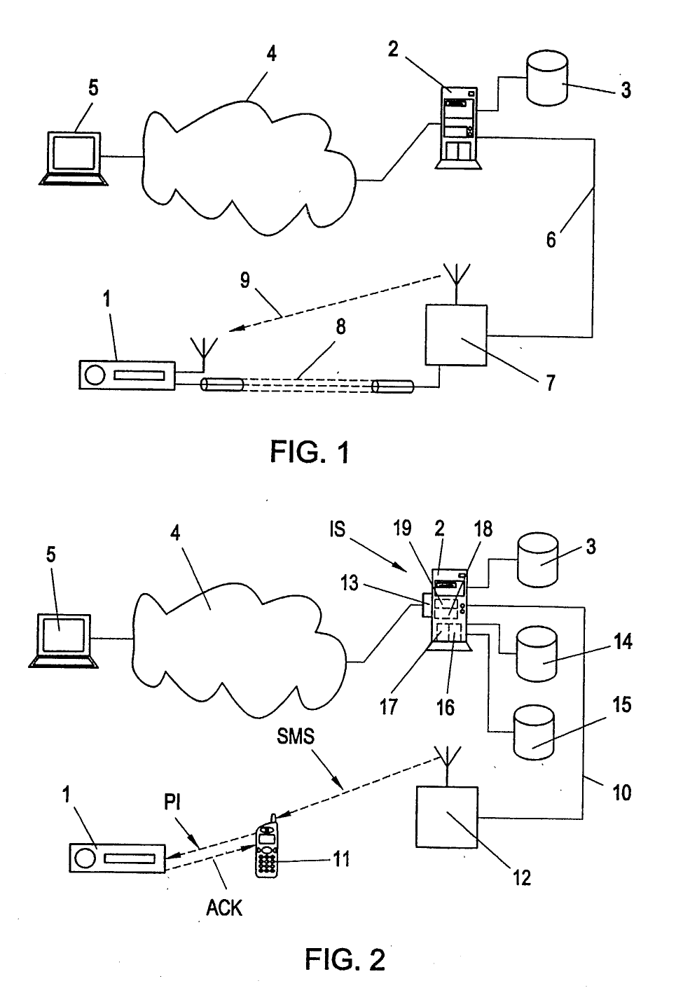

FIG. 1 shows means for implementing a method of providing a programming information for programming a programmable appliance in accordance with the prior art,

FIG. 2 diagrammatically shows means for implementing a method of providing a programming information for programming a programmable appliance,

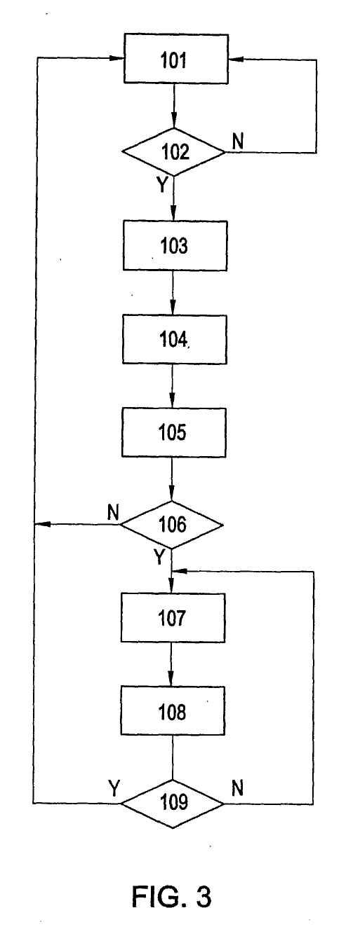

FIG. 3 is a flowchart showing the process steps performed in a communication device for recognizing the programming information contained in a short message and for passing on the programming information to a programmable appliance,

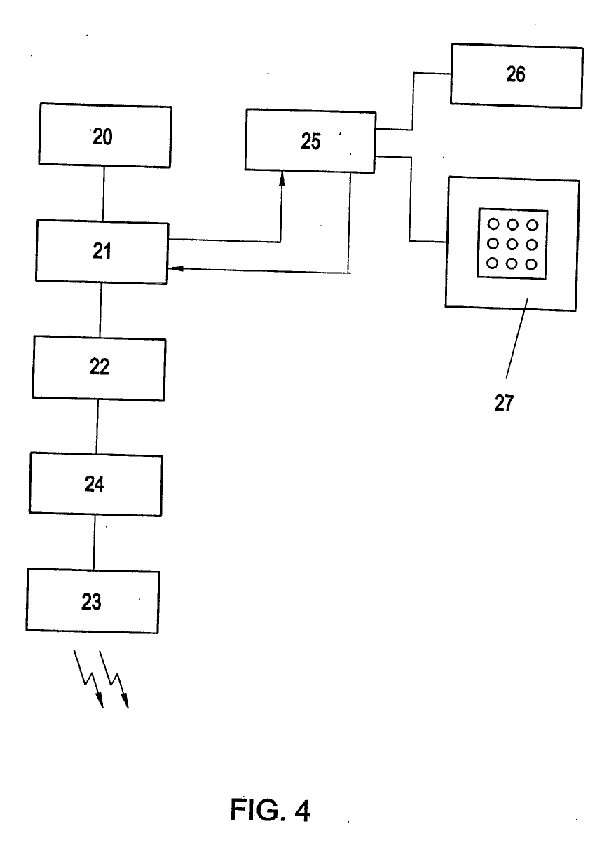

FIG. 4 is a block diagram of part of a mobile telephone constructed in accordance with the invention as a communication device according to the invention, and

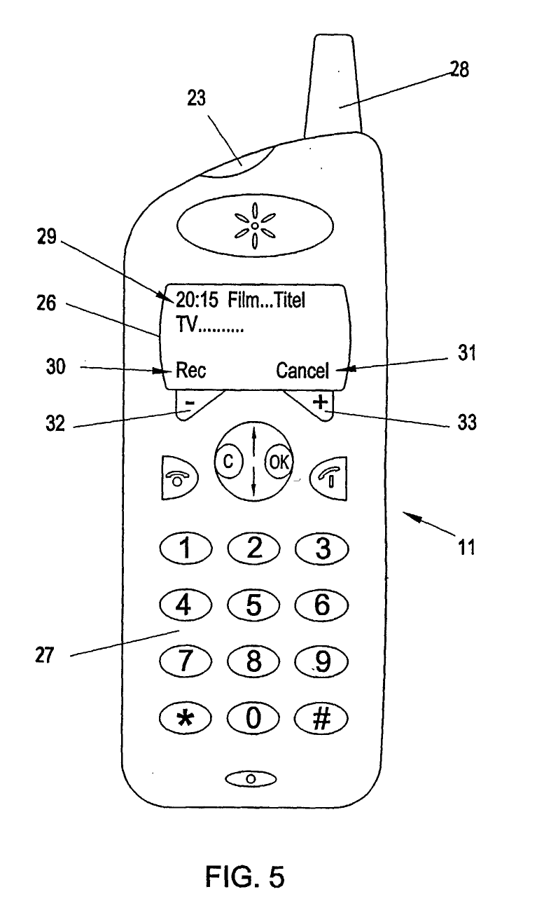

FIG. 5 is a plan view of a mobile telephone constructed according to the invention as a communication device according to the invention.

FIG. 1 diagrammatically shows means for implementing a method of providing a programming information PI to a programmable device or appliance 1 in accordance with the prior art. This comprises a server 2 which makes available the programming information PI stored in a database, for example the programming information on TV broadcasts from various TV stations. In particular, the server 2 is connected to a data network 4, in this case to the Internet, and is capable, for example, of cyclically scanning all providers of programming information PI and storing their programming data in the database 3. The programming information provided by the server 2 may then be called up by means of a terminal 5, which is also connected to the data network 4, i.e. the Internet. Servers usual at present, so-termed EPG (Electronic Programming Guide) servers 2, may be accessed via the Internet and their program contents may be called up. After a user has identified himself, a given programming information PI may be selected, which information may be passed on to a transmitter device 7, for example a TV transmitter, via a link 6 after its authority has been tested. Then the programming information PI can be passed on to a programmable device 1, for example a video recorder, via a cable connection 8 or a radio link 9. It is a disadvantage of this method that the transmission of the programming information PI from the server 2 to the programmable appliance 1 may be subject to a delay of up to several hours, so that spontaneous programming actions performed on the appliance 1 are not possible. In addition, the transmission of the programming information PI by the transmitter device 7 in the TV signal is very expensive and/or complicated for reasons of channel occupancy. Furthermore, the programmable appliance 1, for example the video recorder, must be equipped with a suitable receiver unit and must also be ready to receive at all times, i.e. be switched on, for receiving the programming information PI.

FIG. 2 shows means for implementing a method according to the present invention, wherein a programmable appliance 1, for example a video recorder, can be programmed by means of so-termed short messages (SMS). An information providing device 2 makes the programming information PI stored in a database 3 available to a user, for example via a data network 4, the Internet in the present case, from where it can be called up and selected via a suitable terminal 5. The selected programming information PI is passed on as a short message (SMS) by output means 10 to a communication device 11. For this purpose, the selected programming information PI is suitably processed in the information providing device 2 and brought into a format of a short message (SMS), which is transmitted by a corresponding transmitter unit of the mobile telephone network 2, whereupon it is received in a manner known per se by the corresponding communication device 11, a mobile telephone in this case. The short message (SMS) is put into intermediate storage in the communication device 11 and it is recognized here that it relates to a programming information PI. After a manual decision as to whether the programming information PI is to be used for programming the appliance 1, this programming information PI is transmitted to the programmable appliance 1 via the infrared link of the communication device 11. The programmable appliance 1 then transmits an acknowledgement message ACK to the infrared interface of the communication device 11, so that the user is aware of the correct programming or a possible programming error, as applicable. This acknowledgement message of the programmable appliance 1 may also be achieved optically on a display of the programmable appliance 1 or an acoustic signal generated by the programmable appliance 1. Suitable identification means 13 are provided here for enabling the user to access the information providing device 2, which means are preferably contained in the information providing device 2. After the user has been correctly identified, a corresponding input of user-specific data into a user database 14 takes place. The data of the user database 14 may be used for various purposes, for example for the automatic selection of certain programming data PI and, for example, information on the programmable device 1, for example the type of video recorder. In addition, a statistical database 15 for the storage of statistical data is also provided, in which, for example, the selection of the programming information PI by the user is laid down for future invoicing. The database 3 for the programming information PI as well as the user database 14 and the statistical database 15 may be integrated into the information providing device 2. Furthermore, the information providing device 2 comprises encoding and decoding means 16 for encoding and decoding in particular the user-specific and statistical data. Furthermore, a device 17 for the speech-controlled selection of programming information PI stored in the database 3 is also provided in the information providing device 2. A user may, for example, contact the information providing device 2 via a mobile telephone in this manner and select the programming information PI by spoken commands. A device 18 for forming the short messages (SMS) representing or containing the respective selected programming information PI is also contained in the information providing device 2. The programming information PI is selected, preferably taking into account the data present in the user database 14 and in the statistical database 15, with the use of a device 19 for automatic selection of the programming information PI, which is also integral with the information providing device 2, and this programming information is automatically passed on to the communication device 11 of the user. Selected programming information PI may thus be transmitted to the user in a targeted manner.

The information providing device 2, the database 3, the output means 10, and the transmitter unit 12 of the mobile telephone network, together with the user database 14 and the statistical database 15, form an information providing system IS.

The communication device 11, which is shown in more detail in FIGS. 4 and 5, comprises a receiver unit 20 for receiving short messages (SMS) and a special recognition unit 21 for recognizing the programming information PI transmitted in the form of a short message (SMS), and in this case additional means 22 for separating the programming information PI contained in the short message (SMS), as well as means 23 for passing on the programming information PI to the appliance 1. Furthermore, a device 24 for selecting a coding type for the programming information PI in dependence on the programmable appliance 1 is contained in the communication device 11 in this case.

FIG. 3 is a flowchart of the process steps in the reception of a short message (SMS) containing program information PI by a communication device 11, formed by a mobile telephone in this case. In a box 101, an SMS display module, which is routinely present in each mobile telephone, tests during the selection of a short message (SMS) for display on the mobile telephone whether this is a short message (SMS) containing a programming information PI. If this is not the case, the short message (SMS) is processed further in a usual manner. If the short message (SMS) is a short message (SMS) according to the invention with programming information PI contained therein, however, the process continues in box 103, where the text content of the short message is transmitted to the display unit of the communication device 11. In box 104, the programming information PI is separated from the short message (SMS), and in box 105 a suitable coding for the programming information PI is selected in dependence on the programmable appliance 1. Box 106 waits for a user command, for example pressing of a programming button. If such a button operation is not performed, or a “clear” button is pressed, the process is continued in box 101. However, if the programming button is pressed on the communication device 11, the correspondingly coded programming information PI is sent to the programmable appliance 1 in box 107, and in box 108 the display device of the communication device 11 will show a corresponding message such as, for example, “programming completed”. In a next box 109, a scan is performed as to whether a programming error has occurred. If this is the case, the process continues with box 107. If the programming was correct, the process continues with box 101.

FIG. 4 is a block diagram of part of a communication device 11 constructed as a mobile telephone, where a recognition device 21 for recognizing short messages (SMS) containing programming information PI is connected to the usual receiver part 20 for short messages (SMS). The programming information PI recognized in the recognition device 21 is passed on to a user interface 25 and displayed on a display device 26 of the communication device 11. The programming information may be transmitted or passed on to the programmable appliance 1 by means of a keyboard 27 of the communication device 11, and a selection may be made from several coding types for the programming information PI. The user interface 25 provides a corresponding response to the recognition device 21, and the programming information PI is finally separated from the short message (SMS) in the means 22 for separating the programming information PI. The device 24 carries out a selection of a coding type. The selection of the coding type, however, may preferably be made in the information providing device 2 already on the basis of the information about the programmable appliance 1 stored in the user database 14. If the programming information PI may be suitable for several programmable appliances 1, however, it is expedient to make a selection of the coding type on the communication device 11 in accordance with the desired programmable appliance 1. The programming information PI is finally transmitted to the programmable appliance 1 by the means 23 for passing on the programming information PI. The means 23 are formed by an infrared transmitter in this case.

FIG. 5 shows a communication device 11 constructed as a mobile telephone which is fitted with a display device 26 and a keyboard 27 in usual manner. The short message (SMS) is received through an antenna 28 of the mobile telephone, and the corresponding text component 29 of the short message (SMS) is displayed on the display device 26. For example, the abbreviation “Rec” may be shown on the display device 26 in a text field 30 so as to indicate a recording, and the text “Cancel” may be shown in a text field 31 for canceling. The relevant programming information PI may either be transmitted to the programmable appliance 1 or be cancelled with the aid of the keys 32 and 33 below the text fields 30 and 31, respectively. If a film is to be recorded as shown in the text portion 29, the programming information PI suitably encoded is passed on to the programmable appliance 1, for example the video recorder, via the infrared interface 23.

The solutions for programming a device or appliance 1, in particular a video recorder, shown in the Figures merely relate to possibilities of using the method according to the invention.

1. A method of providing a programming information for programming a programmable device or appliance (1), wherein the programming information (PI) is selected from a database (3), and the programming information (PI) is transmitted to a communication device (11) in the form of an electronically transmittable message (SMS), which communication device (11) is designed for receiving said message (SMS), and the programming information (PI) is made available to the programmable device or appliance (1) by the communication device (11).

2. A method as claimed in claim 1, wherein the programming information (PI) is selected from the database (3) via a data network (4), in particular via the Internet.

3. A method as claimed in claim 1, wherein the programming information (PI) is selected from the database (3) by means of a speech signal generated with the communication device (11).

4. A method as claimed in claim 1, wherein the programming information (PI) is selected from the database (3) by means of a message (SMS) generated with the communication device (11).

5. A method as claimed in claim 1, wherein the programming information is selected from the database (3) by means of the communication device (11) through the use of the Wireless Application Protocol (WAP).

6. A method as claimed in claim 1, wherein an identification of a user is carried out before the programming information (PI) is selected.

7. A method as claimed in claim 6, wherein user-specific data are entered and stored in a user database (14) after the user has been identified.

8. A method as claimed in claim 1, wherein statistical data on the user-specific selection of the programming information (PI) are stored in a statistical database (15).

9. A method as claimed in claim 7 and/or 8, wherein the selection of the programming information (PI) and its transmission in the form of a message (SMS) to the communication device (11) takes place automatically, preferably taking into account the user-specific data of the user database (14) and/or the statistical data of the statistical database (15).

10. A method as claimed in claim 1, wherein the programming information (PI) is used for programming a programmable recording device, in particular a video recorder.

11. An information providing system (IS) for providing a programming information (PI) for a programmable device or appliance (1) with a database (3) containing the programming information (PI) from which the programming information (PI) can be selected, and with a device (18) for forming a message (SMS) which can be electronically transmitted, which message represents the selected programming information (PI), and with output means (10) for providing the message (SMS) to a communication device (11) which is constructed for making the programming information (PI) available to the programmable device or appliance (1).

12. An information providing system (IS) as claimed in claim 11, wherein the output means (10) are designed for making contact with a transmitter unit (12) of a mobile telephone network.

13. An information providing system (IS) as claimed in claim 11, wherein identification means (13) are provided for identifying the user who selects the programming information (PI).

14. An information providing system (IS) as claimed in claim 11, wherein a user database (14) is provided for the storage of user-specific data.

15. An information providing system (IS) as claimed in claim 11, wherein a statistical database (15) is provided for the storage of statistical data.

16. An information providing system (IS) as claimed in claim 14 and/or 15, wherein encoding and decoding means (16) are provided for encoding and decoding the user-specific data and/or the statistical data.

17. An information providing system (IS) as claimed in claim 11, wherein a device (17) is provided for a speech-controlled selection of the programming information (PI) by the user.

18. An information providing system (IS) as claimed in claim 11, wherein a device is provided for selecting the programming information (PI) by means of a message (SMS), which message (SMS) can be generated by the communication device (11).

19. An information providing system (IS) as claimed in claim 11, wherein a device (19) is provided for automatically selecting the programming information (PI), preferably on the basis of user-specific and/or statistical data.

20. An information providing system (IS) as claimed in claim 11, wherein means for connecting to a data network (4), in particular to the Internet, are provided.

21. A communication device (11) for making a programming information (PI) available to a programmable appliance (1), with a receiver unit (19) for receiving a message (SMS) which can be transmitted electronically and which represents the programming information (PI), and with a recognition unit (20) for recognizing the programming information (PI) transmitted in the form of a message (SMS), and with means (22) for making the programming information (PI) available to the programmable appliance (1).

22. A communication device (11) as claimed in claim 21, wherein the means (22) for making the programming information (PI) available to the appliance (1) are also designed for receiving signals, in particular signals originating from the programmable appliance (1).

23. A communication device (11) as claimed in claim 21, wherein the means (22) for making the programming information (PI) available comprise an infrared interface unit.

24. A communication device (11) as claimed in claim 21, wherein a device (23) is provided for selecting a coding type for the programming information (PI) in dependence on the programmable appliance (1).

25. A communication device (11) as claimed in claim 21, wherein the communication device (11) is formed by a mobile telephone.

26. A method of programming a programmable device or appliance (1) by means of a communication device (I1), which communication device (11) is designed for receiving a message (SMS) which can be transmitted electronically and which represents a programming information (PI), for recognizing the programming information (PI) transmitted as a message (SMS), and for making the programming information (PI) available to the programmable device (1), wherein the programming information (PI) is formed through the use of a message (SMS) put into intermediate storage in the communication device (11), and the programming information (PI) is transmitted by the communication device (11) to the programmable device or appliance (1).

27. A method as claimed in claim 26, wherein the programming information (PI) is transmitted in the RC5 format.

28. A signal representing a message which can be electronically transmitted to a communication device (11), wherein said signal is designed for transmitting a programming information (PI) to the communication device (11), and wherein at least a signal portion of the signal represents a programming information (PI) for programming a programmable device or appliance (1).

29. A signal as claimed in claim 28, wherein the signal comprises an identification signal component for identifying the programming information (PI).

30. A signal as claimed in claim 29, wherein the identification signal component is formed by a string of characters in hexadecimal code.

31. A signal as claimed in claim 29, wherein the identification signal component is formed by a string of characters in accordance with the Extensible Markup Language (XML) standard.

32. A signal as claimed in claim 28, wherein the signal comprises a signal carrier in a frequency range around 36 kHz.
